(19) United States
(12) Patent Application Publication
(10) Pub. No.: US 2015/0139003 A1
(43) Pub. Date: May 21, 2015

(54) MOBILE STATION DEVICE, PATH LOSS CALCULATION METHOD, PROGRAM, AND INTEGRATED CIRCUIT

(71) Applicant: SHARP KABUSHIKI KAISHA, Osaka-shi, Osaka (JP)

(72) Inventors: Hiroki Takahashi, Osaka-shi (JP); Jungo Goto, Osaka-shi (JP); Osamu Nakamura, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 14/401,811

(22) PCT Filed: May 15, 2013
(86) PCT No.: PCT/JP2013/063511

§ 371 Date: Nov. 17, 2014

(30) Foreign Application Priority Data
May 18, 2012 (JP) 2012-114788

(51) Int. Cl. H04W 24/08

(52) U.S. Cl. CPC H04W 24/08
USPC 370/252

(57) ABSTRACT

Disclosed is a mobile station device 101 that receives a first reference signal transmitted at a first time interval and a second reference signal transmitted at a time interval shorter than the first time interval from a base station device, and includes a path loss calculating unit 111 that calculates a path loss based on both of the first reference signal and the second reference signal, or that selects any one of the first reference signal and the second reference signal in accordance with a condition and calculates a path loss. Further, the path loss calculating unit 111 corrects the path loss calculated based on any one of the first reference signal and the second reference signal, based on the other reference signal.

### TECHNICAL FIELD

The invention relates to a technique of calculating a downlink path loss by selectively using plural kinds of reference signals.

### BACKGROUND ART

In recent years, as a radio communication system standard of a cellular phone by Third Generation Partnership Project (3GPP), an operation of Long Term Evolution (LTE) Release 8 (Rel-8) has been started. In addition, as a succeeding standard of LTE Rel-8, LTE Rel-10 (LTE-A: also referred to as LTE-Advanced) and LTE Rel-11 have been standardized.

In an uplink of a radio communication of a cellular phone, transmission power control (TPC) is performed in a mobile station device so that a base station device can receive a transmission signal of the mobile station device with constant electric power. For example, an expression of determining the transmission power to be used in an uplink data signal (referred to as PUSCH) of the mobile station device in LTE Rel-8 and LTE Rel-10 is indicated in Expression (1).

[Math. 1]

P_{PUSCH}=min{P_{CMAX},10 log₁₀(M_{PUSCH})+P₀_{_{—}}_{PUSCH}+αPL+Δ_{TF}+f} (1)

P_{CMAX} indicates a maximum transmission power of a mobile station device. M_{PUSCH} indicates a transmission bandwidth (the number of resource blocks in a frequency direction). Further, P₀_{_{—}}_{PUSCH} indicates the reference reception power of PUSCH. α indicates an attenuation coefficient (path loss compensation coefficient) used in fractional transmission power control of an entire cell. Δ_{TF} is a parameter depending on modulation and coding schemes (MCS) of an uplink signal. Further, f is a value for correcting excess or deficiency of the reception power determined in a TPC command of which the mobile station device is notified from the base station device. In addition, PL is an attenuation amount (path loss) of electric power when transmission is performed between the base station device and the mobile station device, and is calculated from reference signal received power (RSRP) of the reference signal transmitted from known transmission power in a downlink (a communication from the base station device to the mobile station device) by Expression (2).

[Math. 2]

PL=ReferenceSignalPower−higherlayerfilteredRSRP (2)

However, ReferenceSignalPower is a transmission power of a reference signal of which the mobile station device is notified from a higher layer and transmitted by the base station device, and the higherlayerfiltered RSRP is the reception power in which the higher layer performs a filtering process on the value measured by a physical layer. The path loss value of the downlink calculated by Expression (2) is considered to be substantially the same value as the uplink path loss, and is used for the compensation of the uplink path loss.

Here, in LTE Rel-8 and LTE Rel-10, a cell specific reference signal (CRS) is used as a downlink reference signal for measuring the path loss (NPL 1). The CRS is a signal transmitted by using time resources and frequency resources determined for each cell ID, and a mobile station device can calculate a path loss for each cell by using the reception power of the received CRS. Further, with respect to the standardization of Rel-11, the usage of a channel state information-reference signal (CSI-RS) in order to measure the correct path loss in an uplink corporative multipoint or coordinated multipoint (CoMP) is considered (NPL 2).

### CITATION LIST

### Patent Literature

NPL 1: 3GPP TS36.211 v10.4.0
NPL 2: 3GPP TSG RAN WG1 Meeting #67 R1-113648

### SUMMARY OF INVENTION

### Technical Problem

Since downlink reference signals such as CRS or CSI-RS are transmitted by using a downlink radio resource, it is desired to cause the transmission interval to be as long as possible in order that resources for the data signal are not pressed. However, in the case where the transmission interval of the reference signal is caused to be long, if the path loss greatly fluctuates by time due to movement of the mobile station device, the measured path loss does not follow the actual path loss, and an error is generated. As a result, the correct transmission power control is not performed, and the reception power in the base station device does not reach a desired value. Therefore, there are problems in that a desired communication quality is not satisfied, and an interference amount increases.

The invention is made in view of the circumstances described above, and an object of the invention is to provide a mobile station device that can reduce influence from the fluctuation of the path loss by time by selectively using a reference signal of which a transmission interval is long and a reference signal of which a transmission interval is short, a path loss calculation method, a program, and an integrated circuit.

### Solution to Problem

(1) In order to achieve the object described above, the invention has conceived the following means. That is, a mobile station device according to the invention receives a first reference signal transmitted at a first time interval and a second reference signal transmitted at a time interval shorter than the first time interval from a base station device, the mobile station device including a path loss calculating unit that calculates a path loss based on both of the first reference signal and the second reference signal, or that selects any one of the first reference signal and the second reference signal in accordance with a condition and calculates a path loss.

In this manner, the path loss is calculated based on both of the first reference signal and the second reference signal, or any one of the first reference signal and the second reference signal is selected in accordance with a condition and a path loss is calculated. Accordingly, even if the path loss fluctuates within a measurement interval of the path loss, it is possible to reduce the measurement error of the path loss.

(2) Further, in mobile station device of the invention, the path loss calculating unit corrects the path loss calculated based on any one of the first reference signal and the second reference signal, based on the other reference signal.

In this manner, since the path loss calculated based on any one of the first reference signal and the second reference signal is corrected based on the other reference signal, it is possible to perform correction corresponding to fluctuation of the path loss by time, and as a result, when the path loss fluctuates within the measurement interval of the path loss, it is possible to reduce the measurement error of the path loss.

(3) Further, in the mobile station device according to the invention, when a path loss at a predetermined time is calculated, the path loss calculating unit corrects the path loss calculated based on the first reference signal before the predetermined time by a path loss fluctuation amount calculated based on the second reference signals received at a plurality of timings before the predetermined time.

In this manner, when the path loss is calculated at a predetermined time, the path loss calculated based on the first reference signal before the predetermined time is corrected by the path loss fluctuation amount calculated based on the second reference signals received at a plurality of timings before the predetermined time. Therefore, it is possible to reduce the error of the path loss due to the fluctuation by time.

(4) Further, in the mobile station device according to the invention, the path loss calculating unit calculates a difference between the path loss calculated based on the first reference signal and the path loss calculated based on the second reference signal at a time when the first reference signal and the second reference signal are received at the same time, and sets any one of the path loss calculated based on the first reference signal and the path loss calculated based on the second reference signal to be the downlink path loss based on the difference between the respective calculated path losses.

In this manner, the difference between the path loss calculated based on the first reference signal and the path loss calculated based on the second reference signal is calculated at the time the first reference signal and the second reference signal are received at the same time, and any one of the path loss calculated based on the first reference signal and the path loss calculated based on the second reference signal is set to be the downlink path loss based on the difference between the respective calculated path losses. Therefore, it is possible to selectively use a reference signal to be used in the calculation of the path losses in accordance with the difference between respective path losses.

(5) Further, in the mobile station device according to the invention, the path loss calculating unit sets the path loss calculated based on the second reference signal to be the downlink path loss in a case where the difference between the respective calculated path losses is within a predetermined threshold value.

In this manner, when the difference between the respective calculated path losses is within a predetermined threshold value, the path loss calculated based on the second reference signal is set to be the downlink path loss. Therefore, it is possible to reduce the error of the path loss due to the fluctuation by time, while the measurement precision of the path loss is maintained.

(6) Further, in the mobile station device according to the invention, the path loss calculating unit calculates a fluctuation amount within a predetermined interval of the path loss calculated based on the first reference signal or a fluctuation amount within a predetermined interval of the path loss calculated based on the second reference signal and sets any one of the path loss calculated based on the first reference signal and the path loss calculated based on the second reference signal to be the downlink path loss based on the calculated fluctuation amount.

In this manner, a fluctuation amount within a predetermined interval of a path loss calculated based on the first reference signal or a fluctuation amount within a predetermined interval of a path loss calculated based on the second reference signal is calculated, and any one of the path loss calculated based on the first reference signal and the path loss calculated based on the second reference signal is set to be the downlink path loss based on the calculated fluctuation amount. Therefore, in accordance with the fluctuation amount, it is possible to select a reference signal that easily corresponds to the fluctuation by time or to select a reference signal having a long transmission time interval.

(7) Further, in the mobile station device according to the invention, the path loss calculating unit sets the path loss calculated based on the first reference signal to be the downlink path loss in a case where the calculated fluctuation amount is within a predetermined threshold value.

In this manner, when the calculated fluctuation amount is within the predetermined threshold value, the path loss calculated based on the first reference signal is set to be the downlink path loss. Therefore, when it is determined that the fluctuation of the path loss by time is small, it is possible to use the first reference signal having a long transmission time interval. According to this, when the first reference signal has higher measurement precision than the second reference signal, it is possible to reduce the error of the path loss due to the fluctuation by time, and also to enhance the measurement precision of the path loss.

(8) Further, the mobile station device according to the invention further includes an RSRP notifying unit that notifies the base station device of a reference signal received power (RSRP) which is a reception power of a reference signal used by the path loss calculating unit in the calculation of the path loss.

In this manner, the base station device is notified of the RSRP which is a reception power of a reference signal used in the calculation of the path loss. Therefore, it is possible that the base station device uses the RSRP for arbitrary processes such as a handover process or recognition of the amount of movement of a mobile station device.

(9) Further, in the mobile station device of the invention, the RSRP notifying unit notifies the base station device of the RSRP in a case where the path loss calculating unit changes a reference signal used in the calculation of the path loss.

In this manner, when the path loss calculating unit changes a reference signal used in the calculation of the path loss, the base station device is notified of the RSRP. Therefore, an appropriate RSRP can be selected from the first reference signal and the second reference signal and the base station device is notified of the RSRP. As a result, it is possible to reduce the error of the reception power that is recognized by the base station device.

(10) Further, a path loss calculation method according to the invention, is a path loss calculation method of a mobile station device that receives a first reference signal transmitted at a first time interval and a second reference signal transmitted at a time interval shorter than the first time interval from a base station device, the path loss calculation method including a step of calculating a path loss based on both of the first reference signal and the second reference signal, or selecting any one of the first reference signal and the second reference signal in accordance with a condition and calculating a path loss.

In this manner, a path loss is calculated based on both of the first reference signal and the second reference signal, or any one of the first reference signal and the second reference signal is selected in accordance with a condition and a path loss is calculated. Therefore, it is possible to perform the correction corresponding to the fluctuation of the path loss by time. As a result, even if the path loss fluctuates within the measurement interval of the path loss, it is possible to reduce the measurement error of the path loss.

(11) Further, a program according to the invention is a program for a mobile station device that receives a first reference signal transmitted at a first time interval and a second reference signal transmitted at a time interval shorter than the first time interval from a base station device, and the program causes a computer to execute a process of calculating a path loss based on both of the first reference signal and the second reference signal, or selecting any one of the first reference signal and the second reference signal in accordance with a condition and calculating a path loss.

In this manner, a path loss is calculated based on both of the first reference signal and the second reference signal, or any one of the first reference signal and the second reference signal is selected in accordance with a condition and a path loss is calculated. Therefore, it is possible to perform the correction corresponding to the fluctuation of the path loss by time. As a result, even if the path loss fluctuates within the measurement interval of the path loss, it is possible to reduce the measurement error of the path loss.

(12) Further, an integrated circuit according to the invention is an integrated circuit that is mounted on a mobile station device, and causes the mobile station device to operate a plurality of functions of receiving a first reference signal transmitted at a first time interval and a second reference signal transmitted at a time interval shorter than the first time interval from a base station device; and calculating a path loss based on both of the first reference signal and the second reference signal, or selecting any one of the first reference signal and the second reference signal in accordance with a condition and calculating a path loss.

In this manner, a path loss is calculated based on both of the first reference signal and the second reference signal, or any one of the first reference signal and the second reference signal is selected in accordance with a condition and a path loss is calculated. Therefore, it is possible to perform the correction corresponding to the fluctuation of the path loss by time. As a result, even if the path loss fluctuates within the measurement interval, it is possible to reduce the measurement error of the path loss.

### Advantageous Effects of Invention

According to the invention, even if a reference signal having a long measurement interval of the path loss is used, it is possible to correct the fluctuation of the path loss by time. As a result, even if the path loss fluctuates within the measurement interval of the path loss, it is possible to reduce the measurement error of the path loss.

### BRIEF DESCRIPTION OF DRAWINGS

FIG. 1 is a diagram illustrating a relationship between a true value and a measured value of a path loss.

FIG. 2A is a diagram illustrating an example of a first reference signal according to a first embodiment of the invention.

FIG. 2B is a diagram illustrating an example of a second reference signal according to the first embodiment of the invention.

FIG. 3 is a diagram illustrating a relationship between a true value of the path loss and a measured value using the two kinds of reference signals in the first embodiment of the invention.

FIG. 4 is a block diagram illustrating a simple configuration of a mobile station device that can be used in the first embodiment of the invention.

FIG. 5 is a flow chart illustrating an operation in a path loss calculating unit 111 according to the first embodiment of the invention.

FIG. 6 is a block diagram illustrating a simple configuration of a base station device that can be used in the first embodiment of the invention.

FIG. 7 is a diagram illustrating a relationship between a true value of a path loss and a measured value using a reference signal and a measured value correction method according to a second embodiment of the invention.

FIG. 8 is a flow chart illustrating an operation in the path loss calculating unit 111 according to the second embodiment of the invention.

FIG. 9 is an example of a block configuration of a base station device according to the second embodiment of the invention.

FIG. 10 is a block diagram illustrating a configuration of the path loss calculating unit 111 according to a third embodiment of the invention.

FIG. 11 is a flow chart illustrating an operation of the path loss calculating unit 111 according to the third embodiment of the invention.

FIG. 12 is a diagram illustrating a relationship between a true value of a path loss and a measured value using a reference signal in a fourth embodiment of the invention.

FIG. 13 is a block diagram illustrating a configuration of the path loss calculating unit 111 according to the fourth embodiment of the invention.

FIG. 14 is a flow chart illustrating an operation of the path loss calculating unit 111 according to the fourth embodiment of the invention.

FIG. 15 is a diagram illustrating a block configuration of the mobile station device according to a fifth embodiment of the invention.

FIG. 16 is a block diagram illustrating an example of an internal configuration of an RSRP calculating unit according to the fifth embodiment of the invention.

FIG. 17 is a flow chart illustrating a process in the RSRP calculating unit according to the fifth embodiment of the invention.

FIG. 18 is a diagram illustrating a block configuration of the mobile station device according to a sixth embodiment of the invention.

FIG. 19 is a flow chart illustrating an operation of an RSRP notifying unit 801 according to the sixth embodiment of the invention.

### DESCRIPTION OF EMBODIMENTS

According to the respective embodiments described below, a method of improving a tracking performance in a case where a path loss fluctuates by time when the path loss is measured by using a downlink reference signal transmitted in a relatively longer cycle is disclosed.

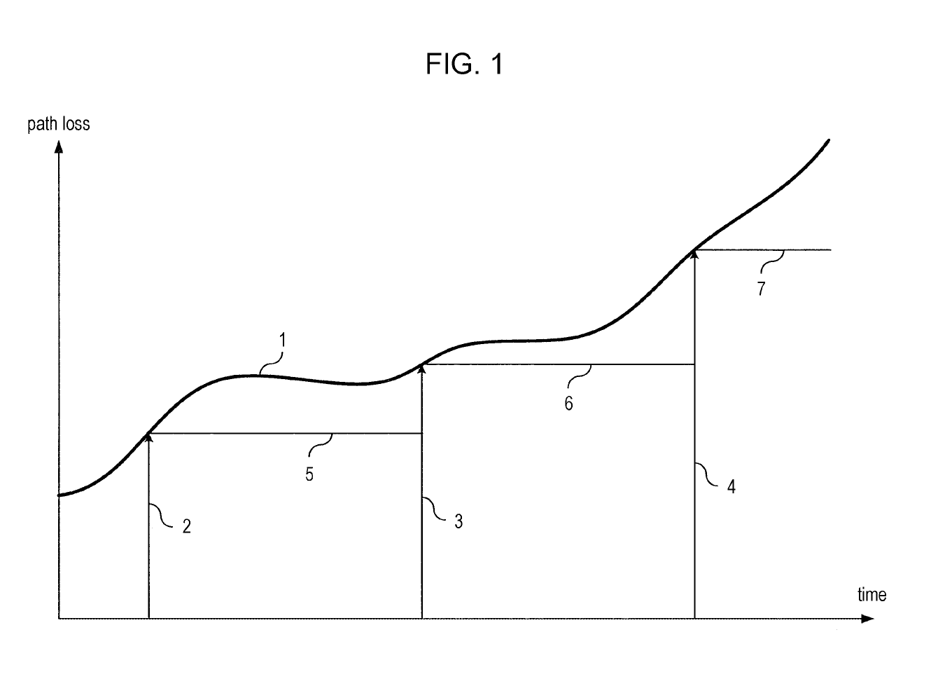

FIG. 1 is a diagram illustrating a relationship between a true value and a measured value of a path loss. A concept of the invention is described with reference to FIG. 1. In FIG. 1, the horizontal axis indicates a time, and the vertical axis indicates a path loss. The actual path loss between a mobile station device and a base station device (hereinafter, referred to as a true path loss 1) is indicated by a solid curved line to indicate that the path loss increases by time because the distance from the base station device changes along with the movement of the mobile station device, or the like. Further, path losses (respectively referred to as path losses 2, 3, and 4) measured at timings when the downlink reference signals are received are indicated by arrows. Here, when a path loss calculation expression according to the related art indicated by Expression (2) is used, the calculated path loss may not be measured until the next reference signal is received. Therefore, path losses measured immediately before are used (respectively, referred to as calculated path losses 5, 6, and 7). Accordingly, when the true path loss 1 fluctuates, great errors may occur between the true path loss 1 and the calculated path losses 5, 6, and 7. According to the invention, Expression (3) is used instead of Expression (2) in order to reduce the errors.

[Math. 3]

PL(t+Δt)=ReferenceSignalPower−RSRP(t)+ΔPL(t+Δt) (3)

Here, RPSP(t) is a reception power of a reference signal at the timing t at which the reference signal is received, and is the same as the higherlayer filtered RSRP in Expression (2). ΔPL(t+Δt) is a value for correcting the path loss when a time Δt passes from the timing t when the reference signal is received. That is, according to the invention, an error between an actual path loss and a calculated path loss is reduced by correcting the path loss at a timing when the reference signal is not received.

Hereinafter, ΔPL(t+Δt) is described in detail according to the embodiment.

### First Embodiment

In the first embodiment of the invention, a case of calculating a path loss by using two kinds of downlink reference signals having different transmission intervals is considered. Here, the two kinds of downlink reference signals assumed herein include a first reference signal that has a longer transmission interval and higher measurement precision, and a second reference signal that has a shorter transmission interval and lower measurement precision.

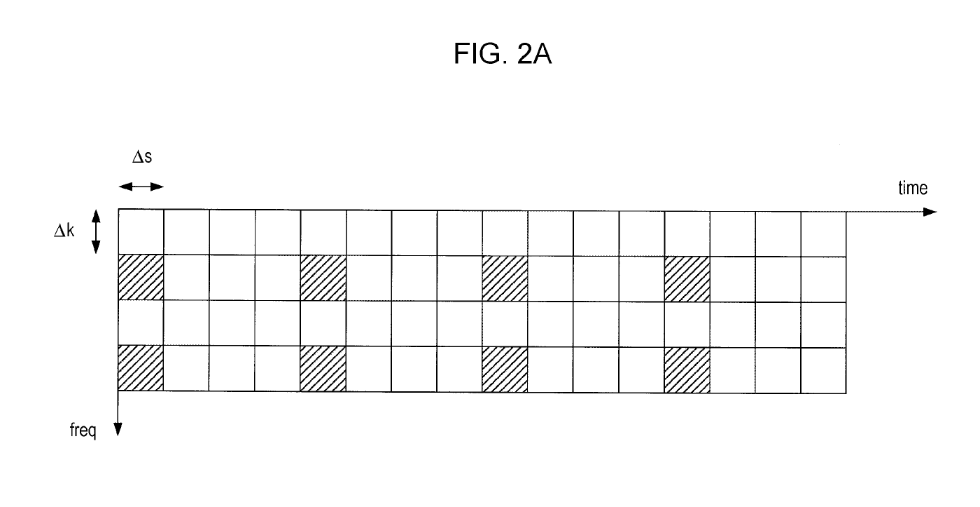

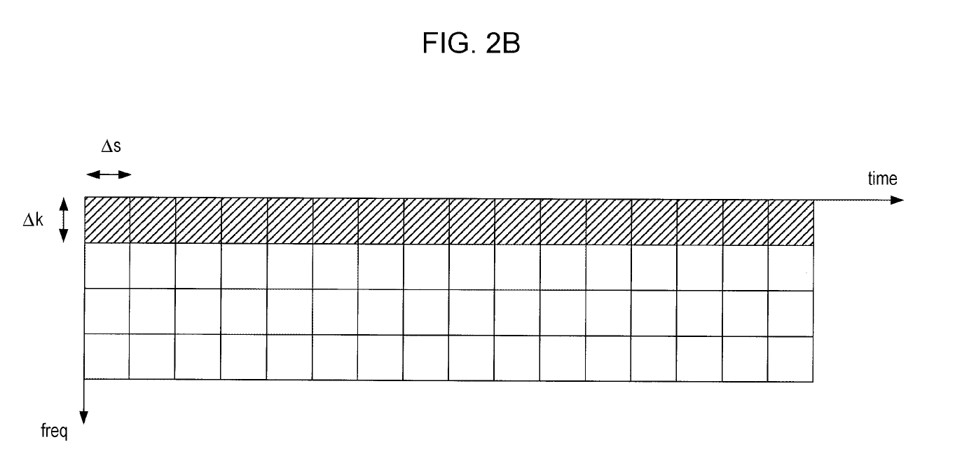

The first reference signal has higher path loss measurement precision at the reception timing. However, when the fluctuation of the path loss by time is great, the error of the path loss due to the fluctuation is generated immediately before the timing when the next first reference signal is received. It is assumed that the second reference signal is a signal in which an error from the actual path loss is great but the fluctuation amount of the path loss by time can be tracked, since the measurement precision is low. That is, in the embodiment, it is considered that the path loss having the high measurement precision is calculated using the first reference signal, and the fluctuation by time is corrected by using the second reference signal. Examples of the first reference signal and the second reference signal are described with reference to FIGS. 2A and 2B.

FIG. 2A is a diagram illustrating an example of the first reference signal according to the first embodiment of the invention. In FIG. 2A, the first reference signal is allocated for each 2Δk of frequency bands, but the first reference signal is arranged to be transmitted one time for each 4×Δs in the time direction. Accordingly, the first reference signal has a characteristic in which high path loss measurement precision can be obtained by averaging the influences by the frequency selective fading at the reception timings, but the error is easily generated according to the fluctuation by time.

Meanwhile, FIG. 2B is a diagram illustrating an example of a second reference signal according to the first embodiment of the invention. The second reference signal is arranged at one point of an allocation unit Δk in the frequency direction, but transmitted for each Δs in the time direction. Since such a reference signal easily receives the influence of the frequency selective fading, the reference signal has a characteristic of easily generating the error in the absolute value of the path loss in the measured value, but easily tracking the fluctuation of the path loss according to time.

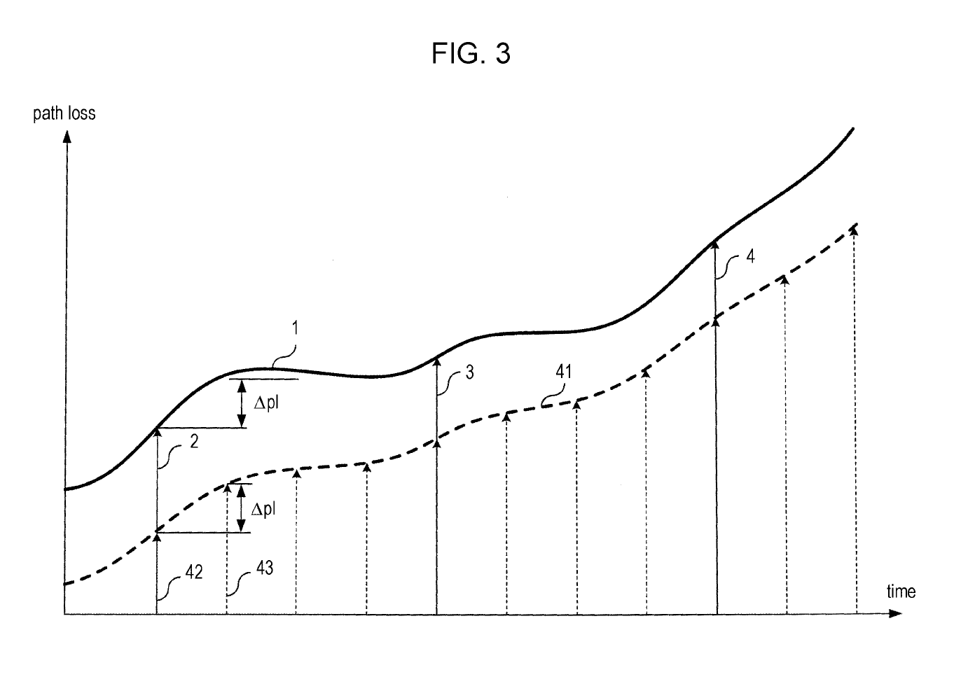

How a mobile station device that receives both of the two reference signals having different characteristics can calculate a path loss is described with reference to FIG. 3.

FIG. 3 is a diagram illustrating a relationship between a true value of the path loss and a measured value using the two kinds of reference signals in the first embodiment of the invention. In FIG. 3, in the same manner as in FIG. 1, the actual path loss value is indicated as the true path loss 1, and the path losses 2, 3, and 4 are the respective values of the path losses measured using the first reference signal. Further, a second path loss 41 illustrated by a broken curved line is a path loss in a frequency in which the second reference signal is allocated, and indicates that the second path loss becomes lower than the true path loss 1 as a whole. However, the drawing illustrates an example, and the second path loss may be greater than the true path loss 1 in some cases. With respect to the fluctuation of the path loss by time as illustrated in FIG. 3, when the path loss has a correlation with the true path loss 1, the error of the first reference signal due to the fluctuation by time can be reduced by adding an error Δpl between a path loss 42 and a path loss 43 measured using the second reference signal to the path loss 2 measured using the first reference signal.

In this manner, in the embodiment, the path loss measurement in which high measurement precision and tracking performance to the fluctuation by time coexist can be performed by correcting the fluctuation by time using the second reference signal based on the path loss measured using the first reference signal.

The invention can be applied to a mobile station device that measures a path loss by using a reference signal received from a base station device and controls transmission power using the path loss, and a radio communication system including the mobile station device. However, the application is not limited to the base station device or the mobile station device, and the invention may be applied to other devices as long as the device has the same function. For example, the invention may be applied to a downlink in which the base station device is a transmission device, and the mobile station device is a reception device.

### [Mobile Station Device Configuration Example]

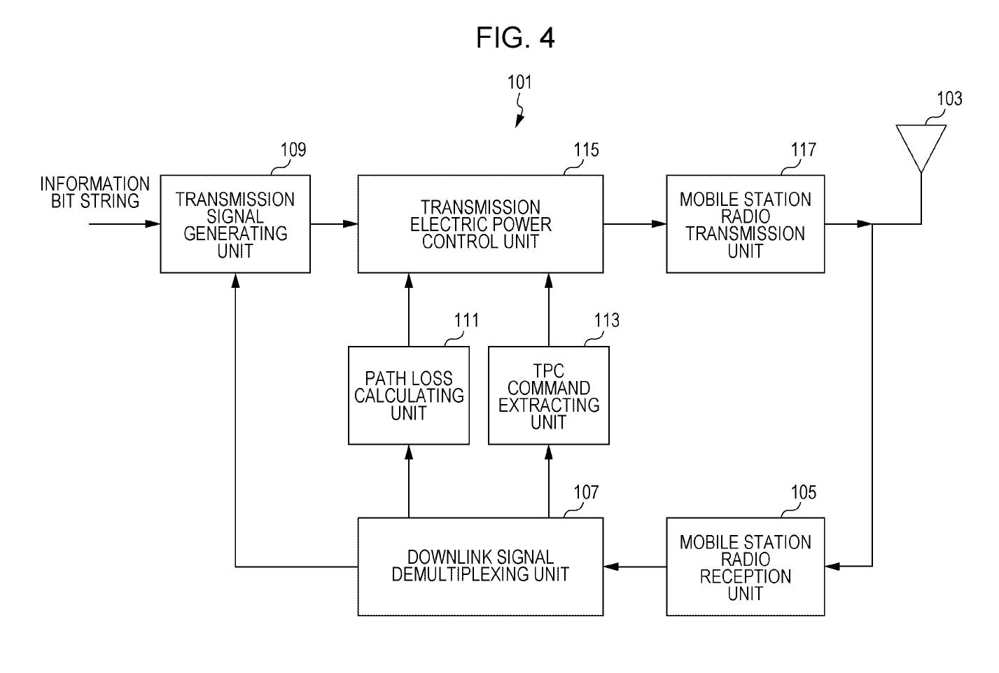

FIG. 4 is a block diagram illustrating a simple configuration of a mobile station device 101 that can be used in the first embodiment of the invention. However, for simplicity of description, minimum blocks required for the description of the invention are illustrated. The mobile station device 101 includes an antenna 103, a mobile station radio reception unit 105, a downlink signal demultiplexing unit 107, a transmission signal generating unit 109, a path loss calculating unit 111, a TPC command extracting unit 113, a transmission electric power control unit 115, and a mobile station radio transmission unit 117.

The antenna 103 has a function of receiving and transmitting a signal. In FIG. 4, the transmission antenna and the reception antenna are the same, but different antennas 103 may be used. The downlink signal received in the antenna 103 is input to the mobile station radio reception unit 105.

The mobile station radio reception unit 105 down-converts the input downlink signal and inputs the input downlink signal to the downlink signal demultiplexing unit 107 after the analog to digital (A/D) conversion.

The downlink signal demultiplexing unit 107 demultiplexes the input signal according to the purpose of use. As a multiplexed signal, for example, a downlink data signal, a downlink reference signal, a downlink control signal, and the like are included, but only a downlink reference signal, a downlink control signal, and a transmit power control (TPC) command are illustrated here, as a signal required for an uplink. The TPC command is, however, a value that indicates the excess or deficiency of the reception power, is notification from the base station device, and is generally included in the downlink control signal. Among the separated downlink control signals, the information required for generating a transmission signal, such as an MCS or an allocation band is input to the transmission signal generating unit 109, the downlink reference signal is input to the path loss calculating unit 111, and the TPC command is input to the TPC command extracting unit 113, respectively. However, the downlink reference signal is configured with the first reference signal and the second reference signal having different reception intervals, and the downlink signal demultiplexing unit 107 inputs the first reference signal and the second reference signal to the path loss calculating unit 111 respectively at the times when the signals are received.

The transmission signal generating unit 109 generates the transmission signal by performing processes of error correction coding, modulation, frequency mapping, or the like based on the MCS or the allocation resource information assigned by the downlink control signal, on the input information bit string, and inputs the generated transmission signal to the transmission electric power control unit 115. However, the transmission signal generated by the transmission signal generating unit 109 is not limited to a data signal based on the information bit string, and any signals can be processed in the same manner as long as the signal is the signal transmitted by an uplink, such as an uplink control signal or an uplink reference signal.

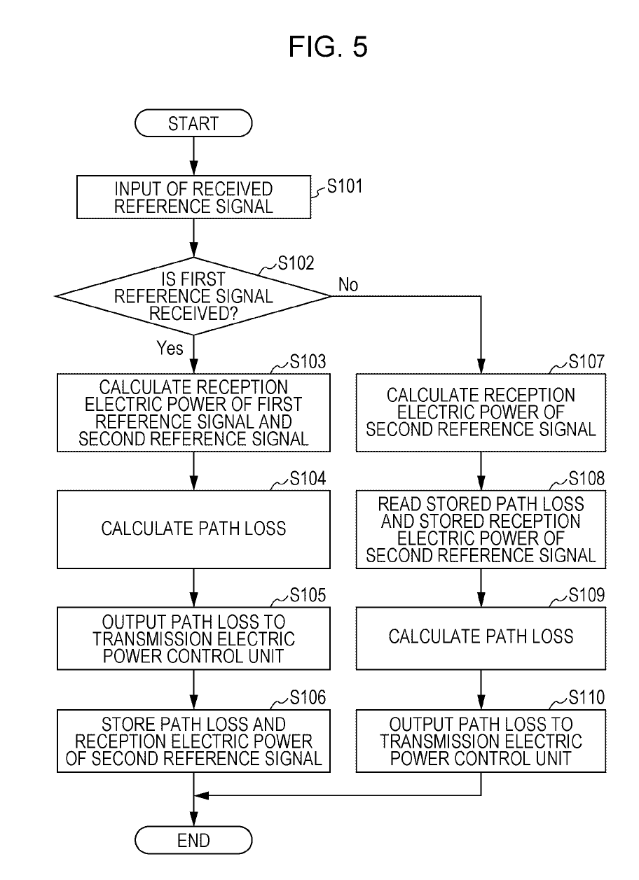

The path loss calculating unit 111 has a function of calculating the path loss from the input reference signal. An operation in the path loss calculating unit 111 is described with reference to a flowchart of (FIG. 5).

FIG. 5 is a flow chart illustrating an operation in the path loss calculating unit 111 according to the first embodiment of the invention. The reference signal is input to the path loss calculating unit 111 from the downlink signal demultiplexing unit 107 (Step S101). At this point, the following processes are different in the case where the input reference signal is two signals of the first reference signal and the second reference signal and in the case where the input reference signal is the second reference signal only (Step S102). When two reference signals are input (here, the time is set to be a time t) (Step S102: Yes), a reception power RSRP₁(t) of the first reference signal and a reception power RSRP₂(t) of the second reference signal are calculated (Step S103). Though it is not illustrated, the path loss calculating unit 111 receives an input of the transmission power of the first reference signal from the base station device through a higher layer, and calculates a path loss PL(t) from the transmission power and the measured reception power of the first reference signal (the calculation method is described below) (Step S104). The path loss calculating unit 111 outputs PL(t) to the transmission electric power control unit 115 (Step S105), stores PL(t) and RSRP₂(t), and ends the process (Step S106). Meanwhile, when only the second reference signal is input (here, the time is set to be a time t′ (>t)) (Step S102: No), a reception power RSRP₂(t′) of the second reference signal is calculated (Step S107). Further, the path loss calculating unit 111 reads the path loss PL(t) and the reception power RSRP₂(t) of the second reference signal which are stored most recently when the first reference signal is received (Step S108), and calculates a path loss PL(t′) from PL(t), RSRP₂(t), and RSRP₂(t′) (the calculation method is described below)(Step S109). PL(t′) is output to the transmission electric power control unit 115, and the process ends (Step S110).

Hereinafter, a path loss calculation method in the path loss calculating unit 111 is described. The path loss calculating unit 111 calculates, by using Expression (4), a path loss at the time t when the first reference signal transmitted at a transmission time interval Δt₁ is received.

[Math. 4]

PL(t)=ReferenceSignalPower₁−RSRP₁(t) (4)

In Expression (4), ReferenceSignalPower₁ is a transmission power value of the first reference signal that is notification from a base station device through a higher layer, and RSRP₁(t) is a reception power value of the first reference signal extracted in the downlink signal demultiplexing unit 107. However, RSRP₁(t) may be a value calculated after arbitrary filtering is performed in the higher layer. Further, a path loss correction value Δpl(t+m×Δt₂) at a time t+mΔt₂ is calculated by Expression (5) by using the reception power RSRP₂(t) at the time t when the second reference signal transmitted at a transmission time interval Δt₂ (<Δt₁) is received and a reception power RSRP₂(t+m×Δt₂) at a time t+m×Δt₂ (m=1, 2, Δt₁/Δt₂−1).

[Math. 5]

Δpl(t+mΔt₂)=RSRP₂(t+mΔt₂)−RSRP₂(t) (5)

Here, RSRP₂(t) is a reception power value of the second reference signal extracted in the downlink signal demultiplexing unit 107. Further, RSRP₂(t) may be a value calculated after arbitrary filtering is performed in the higher layer. With Expressions (4) and (5), the path loss calculating unit 111 calculates the path loss value at the time t+m×Δt₂ by Expression (6).

[Math. 6]

PL(t+mΔt₂)=PL(t)+Δpl(t+mΔt₂) (6)

In the above, the path loss calculated by using Expressions (4) and (6) is input to the transmission electric power control unit 115 at the timing of changing the transmission power. However, if the transmission power control is performed at the timing when the second reference signal is not received, the most recently calculated path loss value is used.

Here, Expressions (5) and (6) are described in an assumption that the second reference signal is received at the time when the first reference signal is received, but the invention is not limited to this. For example, if the second reference signal is not received at the time when the first reference signal is received, RSRP₂(t) in Expression (5) may be the reception power of the second reference signal received at the time closest to the time t or reception power of an arbitrary second reference signal received within a predetermined time from the time t. In this manner, RSRP₂(t+mΔt₂) in Expression (5) may be the reception power of the second reference signal received at the time closest to the time t+mΔt₂ or reception power of an arbitrary second reference signal received within a predetermined time from the time t+mΔt₂.

The transmission electric power control unit 115 sets transmission power by using a transmission power control expression indicated by Expression (1) from the input path loss and the TPC command so that the transmission signal input from the transmission signal generating unit 109 can obtain a desired signal quality for the base station device, and inputs the transmission power to the mobile station radio transmission unit 117. Respective parameters except a path loss PL and a TPC command f are not illustrated as inputs, but may be used as notification from a higher layer.

The mobile station radio transmission unit 117 performs digital to analog (D/A) conversion on the input transmission signal and transmits the transmission signal by the antenna 103 to the base station device after up-conversion.

### [Base Station Device Configuration Example]

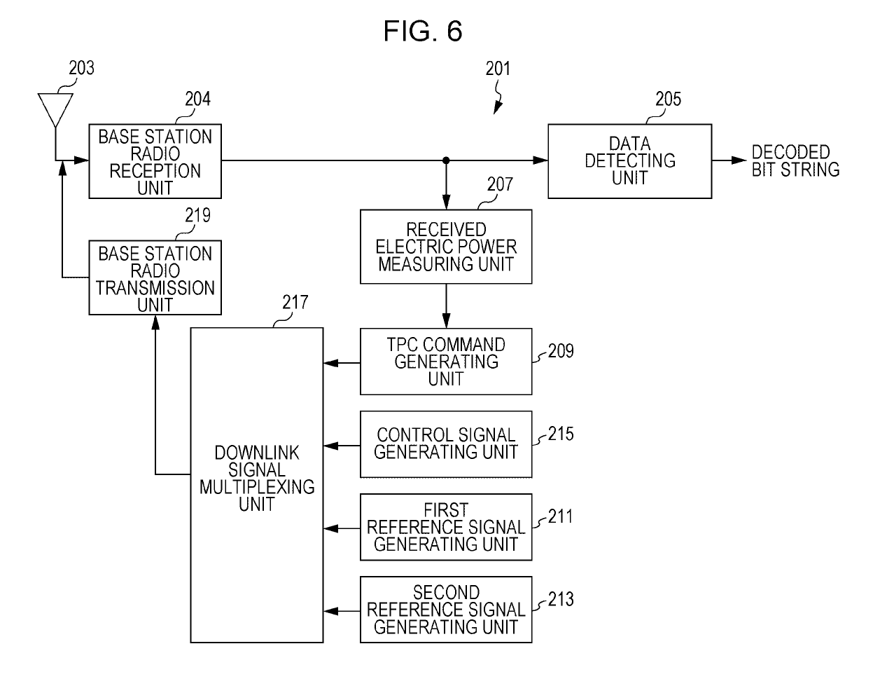

FIG. 6 is a block diagram illustrating a simple configuration of a base station device 201 that can be used in the first embodiment of the invention. An example of the base station device 201 is provided here, but as long as the device is the base station device 201 that can transmit the downlink signal in the same manner, any base station device 201 can be used. For example, though the number of antennas 203 is one in FIG. 6, a plurality of antennas 203 may be included. Further, the antenna 203 may have a function of performing a communication in cooperation with another base station device 201.

The base station device 201 of FIG. 6 includes the antenna 203, a base station radio reception unit 204, a data detecting unit 205, a received electric power measuring unit 207, a TPC command generating unit 209, a first reference signal generating unit 211, a second reference signal generating unit 213, the control signal generating unit 215, a downlink signal multiplexing unit 217, and a base station radio transmission unit 219.

The base station radio reception unit 204 performs down-conversion on signals received from the mobile station devices 101 by an antenna, and inputs the signals to the data detecting unit 205 and the received electric power measuring unit 207 after A/D conversion.

The data detecting unit 205 obtains a decoded bit string by performing processes of demapping, demodulation, decoding, or the like for each of the mobile station devices 101 which are transmission sources, with respect to the input received signals.

The received electric power measuring unit 207 measures the reception power from each of the mobile station devices 101 from the input received signals, and inputs the reception power to the TPC command generating unit 209. In the measurement, for example, an uplink reference signal included in the uplink signal is used. Since the uplink reference signal can be separated for each of the received mobile station devices 101, the reception power for each of the mobile station devices 101 is calculated by using the separated reference signals.

The TPC command generating unit 209 respectively calculates differences between the input reception powers for the respective mobile station devices 101 and the reference reception power set in the base station device 201 in advance, generates the TPC commands for notifying the mobile station devices 101 of the excess or the deficiency of the reception powers, and inputs the TPC commands to the downlink signal multiplexing unit 217. For example, the TPC commands are 2-bit information indicating any one of four values of [3, 1, 0, and −1], and information for assigning the mobile station devices 101 to change the transmission powers respectively by +3 dB, +1 dB, 0 dB, and −1 dB.

The control signal generating unit 215 generates control signals for notifying the mobile station devices 101 of the MCSs or the allocation bands that are used by the respective mobile station devices 101 in uplink transmissions, and inputs the control signals to the downlink signal multiplexing unit 217.

In the first reference signal generating unit 211, first reference signals at a predetermined transmission interval are generated and input to the downlink signal multiplexing unit 217. Further, in the second reference signal generating unit 213, second reference signals having a transmission interval shorter than the first reference signals are generated, and input to the downlink signal multiplexing unit 217. Since the second reference signals are used for measuring the fluctuation amount of the path loss by time as indicated in Expression (5), it is desirable that the second reference signals are generated synchronously at least at timings when the first reference signals are generated.

The downlink signal multiplexing unit 217 performs a multiplexing process in a time domain or a frequency domain for notifying the respective mobile station devices 101 of the input signals as downlink signals. Here, the input signals may include downlink data signals (not illustrated). Further, the notification information such as the TPC command may be multiplexed as a portion of the data signals.

The base station radio transmission unit 219 performs up-conversion on the downlink signals generated by the downlink signal multiplexing unit 217 after the D/A conversion, and transmits the downlink signals to the respective mobile station devices 101 by the antennas 203. The invention can be realized by using the mobile station devices 101 and the base station device 201 described above.

In the description above, a case where the correction value of the path loss is calculated from the second reference signal by using Expression (5) is described, but the numerical expression to be used is not limited to Expression (5). For example, if the correlation between the fluctuations of the first reference signal and the second reference signal by time is low, it is considered to perform weighting by a weight γ equal to or lower than 1 in the same manner as Expression (7).

[Math. 7]

PL(t+mΔt₂)=PL(t)+γΔpl(t+mΔt₂) (7)

In the embodiment, with respect to the first reference signal and the second reference signal, the measurement precision is different due to the allocated number of frequency resources varying, but the invention is not limited to this. For example, in 3GPP, as downlink reference signals, there are reference signals which are called cell-specific reference signal (CRS) and in which different arrangements are used for each cell, and reference signals which are called channel state information-reference signal (CSI-RS) and which are selected from a plurality of candidates and used by the base station device 201. It is known that when cooperative communication is performed in an uplink, if a plurality of base station devices 201 use the same cell ID, the measurement precision of the path loss from the base station devices 201 decreases in CRS. Accordingly, the same effect can be achieved by setting the first reference signal to be CSI-RS, and the second reference signal to be CRS according to the embodiment.

In the above, according to the embodiment, while obtaining high path loss measurement precision using the first reference signal, it is possible to decrease the generation of errors due to the fluctuation of the path loss by time by using the second reference signal.

### Second Embodiment

According to a second embodiment of the invention, ΔPL(t+Δt) in Expression (3) is obtained by extrapolation using a past path loss measurement value. A reception power calculated from a reference signal received at a certain reference signal reception timing t is set to be RSRP(t), and the reference signals are received at a time interval Δt₀. If a reception power calculated from a reference signal received at a reference signal timing t−Δt₀ one signal before is set to be RSRP(t−Δt₀), a path loss correction value ΔPL(t+Δt) when Δt passes from the timing t is determined by Expression (8).

$$\begin{matrix}[ Math . 8 ] & \\ Δ PL ( t + Δ t ) = \frac{- ( RSRP ( t ) - RSRP ( t - Δ {t}_{0} ) )}{Δ {t}_{0}} Δ t & ( 8 )\end{matrix}$$

By using Expression (8), it can be predicted that when the path loss fluctuation increases, the mobile station device 101 moves away from the base station device 201 and still moves away in the next moment, so that the path loss can be corrected to be higher. In contrast, when the path loss fluctuation decreases, the path loss can be corrected to be lower.

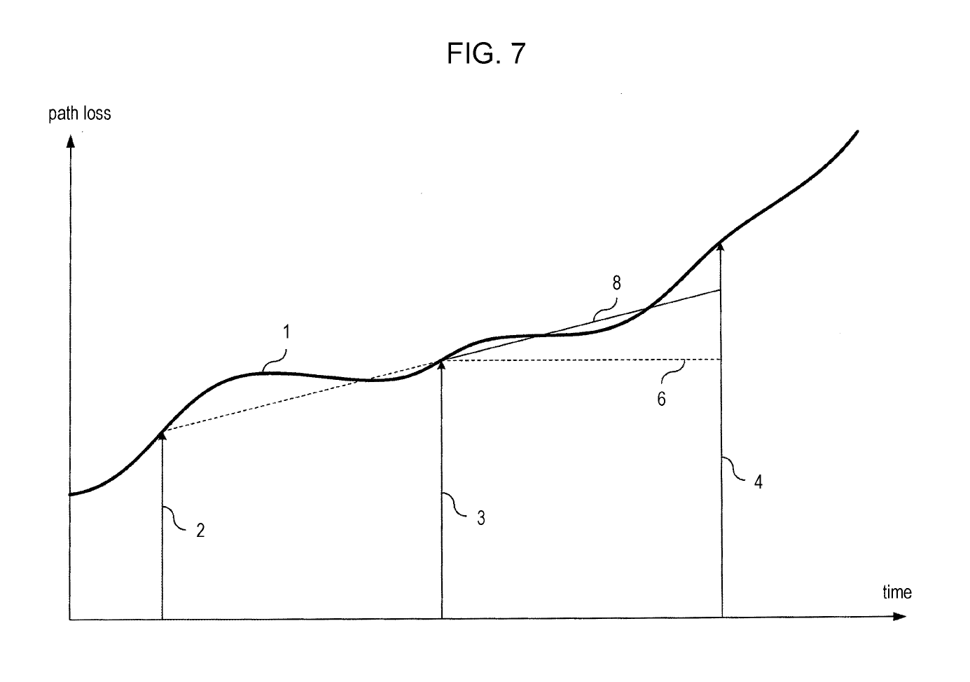

FIG. 7 is a diagram illustrating a relationship between a true value of a path loss and a measured value using a reference signal and a measured value correction method according to the second embodiment of the invention. A case is described with reference to FIG. 7 in which the correction value according to the embodiment is used in the example of FIG. 1 described above. In FIG. 7, elements denoted by reference numerals same as in FIG. 1 are the same elements illustrated in FIG. 1. Here, the path loss used between the timing when the reference signal for determining the path loss 3 is received and the timing when the reference signal for determining the path loss 4 is received is indicated by the calculated path loss 8. The calculated path loss 8 is obtained by extrapolating fluctuation between the path loss 3 and the path loss 2 measured immediately before. Therefore, it is found that the calculated path loss 8 increases as time passes, compared with the calculated path loss 6 according to the related art in which the fluctuation by time is not considered. As a result, it is found that the error from the true path loss 1 that has a tendency to increase is reduced.

However, a case is considered in which the estimated value of PL(t+Δt) is a negative value when ΔPL(t+Δt) of Expression (8) is used in Expression (3), and the value of ΔPL(t+Δt) is negatively great. It may not be considered that PL becomes negative, so Expression (9) may be used by transforming Expression (3).

[Math. 9]

PL(t+Δt)=min(ReferenceSignalPower−RSRP(t)+ΔPL(t+Δt),PLₘᵢₙ) (9)

Here, PLₘᵢₙ is a fixed value determined in advance, and when PL(t+Δt) is caused not to be a negative value, PLₘᵢₙ=0 is set. Further, when PL(t+Δt) is caused not to be an extremely small value, PLₘᵢₙ is set to be a value equal to or greater than 0.

Further, when the path loss is not measured in t−Δt₀, Expression (8) is not applied. In such case, Expressions (3) and (8) are not used, and the path loss calculation expression according to the related art indicated by Expression (2) may be used. Otherwise, in Expression (3), ΔPL(t+Δt)=0 may be set.

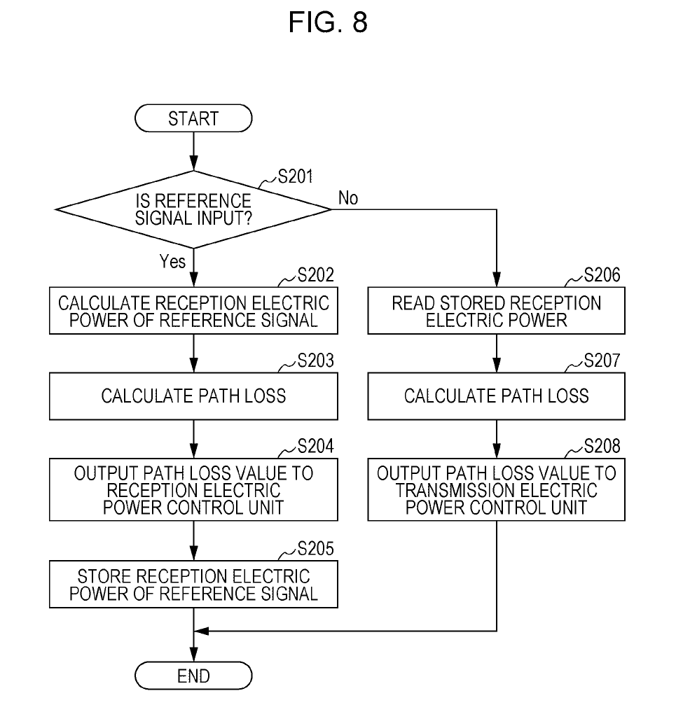

The mobile station device 101 according to the embodiment may be realized by the block configuration of FIG. 4 according to the first embodiment. However, since the path loss calculation method in the path loss calculating unit 111 is different, the path loss calculation method is described with reference to the flow chart of (FIG. 8).

FIG. 8 is a flow chart illustrating an operation in the path loss calculating unit 111 according to the second embodiment of the invention. The path loss calculating unit 111 performs different processes according to whether a downlink reference signal is input at the time of calculating a path loss (Step S201).

If a downlink reference signal is input at a certain time t (Step S201: Yes), the reception power of the reference signal is calculated (Step S202), and the path loss is calculated by using Expression (10) (Step S203).

[Math. 10]

PL(t)=ReferenceSignalPower−RSRP(t) (10)

Though it is not illustrated in FIG. 4, ReferenceSignalPower is a transmission power value of a downlink reference signal that is notification from the base station device 201 through a higher layer, and RSRP(t) is a reception power value of the downlink reference signal extracted in the downlink signal demultiplexing unit 107. RSRP(t) may be a value calculated after certain filtering is performed in the higher layer. The calculated path loss PL(t) is output to the transmission electric power control unit 115 (Step S204). In addition, the path loss calculating unit 111 stores the reception power RSRP(t) of the downlink reference signal, and ends the process (Step S205).

Meanwhile, at the time t+Δt(Δt<Δt₀) when the downlink reference signal is not received (Step S201: No), the path loss calculating unit 111 reads the stored reception powers RSRP(t) and RSRP(t−Δt₀) (Step S206), and the path loss is calculated by using Expression (3) (or Expression (9)) and Expression (8) (Step S207). Here, Δt₀ is the transmission interval of the downlink reference signal. The path loss calculating unit 111 outputs the calculated path loss PL(t+Δt) to the transmission electric power control unit 115 and ends the process (Step S208).

The TPC command extracting unit 113 extracts information about the TPC command. For example, the TPC command is notification from the higher layer through the data signal. In this case, a restoration process of the data signal input from the downlink signal demultiplexing unit 107 is performed, and a bit indicating the TPC command is input to the transmission electric power control unit 115.

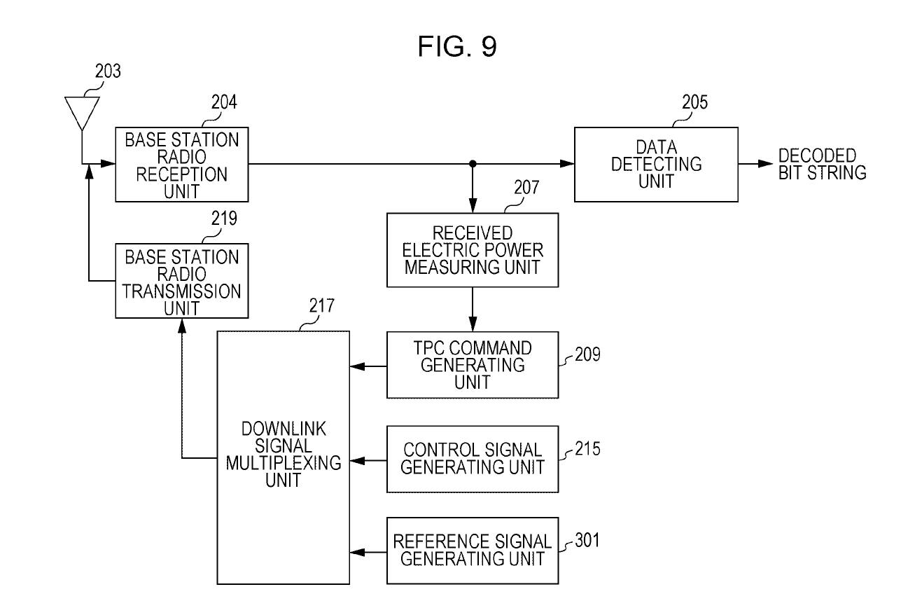

FIG. 9 is an example of a block configuration of the base station device 201 according to the second embodiment of the invention. The base station device 201 of FIG. 9 has a configuration in which the first reference signal generating unit 211 and the second reference signal generating unit 213 are removed and a reference signal generating unit 301 is added with respect to the base station device 201 of FIG. 6 according to the first embodiment. Since the other blocks have the same functions, the elements are denoted by the same reference numerals and the descriptions thereof are omitted.

The reference signal generating unit 301 generates a reference signal for causing the mobile station device 101 to measure a performance of a channel from the base station device 201, and inputs the reference signal to the downlink signal multiplexing unit 217.

The embodiment in which the path loss is calculated by Expressions (3) and (8) at a timing when a downlink reference signal is not received is described, but it is possible to use other expressions. For example, Expression (11) is included.

$$\begin{matrix}[ Math . 11 ] & \\ PL ( t + Δ t ) = PL ( t ) + β \frac{- ( RSRP ( t ) - RSRP ( t - Δ {t}_{0} ) )}{Δ {t}_{0}} Δ t & ( 11 )\end{matrix}$$

Here, β is a weighting coefficient configured by the mobile station device 101. When β=1, the same processes as in Expressions (3) and (8) are performed in Expression (11). The prediction by the extrapolation in Expression (8) may cause a great difference between a predicted value and an actual value depending on the movement speed of the mobile station device 101 in some cases. Accordingly, the correction amount by extrapolation can be appropriately adjusted by using β as in Expression (11).

Further, the path loss is calculated by immediately preceding two downlink reference signals in Expressions (10) and (11), but the path loss can be calculated from the N downlink reference signals in the same manner as in Expression (12).

$$\begin{matrix}[ Math . 12 ] & \\ PL ( t + Δ t ) = PL ( t ) + \{ {\sum }_{n = 1}^{N - 1} {β}_{n} \frac{- ( RSRP ( t ) - RSRP ( t - Δ {t}_{0} ) )}{Δ {t}_{0}} \} Δ t & ( 12 )\end{matrix}$$

Here, βₙ is a weighting coefficient with respect to the path loss measured n times before. In this manner, it is possible to reflect the earlier fluctuation of the path loss by calculating the path loss using downlink reference signals three or more times.

Further, according to the embodiment, the extrapolation is performed linearly, but the prediction may be performed by using polynomial interpolation of equal to or greater than quadric or spline interpolation. Further, a case in which the electric power measurement by the prediction is used in TPC is described as an example, but the prediction may be used for other purposes such as an SNR used at the time of MMSE weighting calculation and a reception quality measurement for MCS selection.

As described above, in the embodiment, the fluctuation by time is predicted from a plurality of path loss values measured from the reference signals received in the past and the path loss values at timings when the reference signals are not received are corrected, so that the error in the calculated path loss can be reduced more than in the prior art.

### Third Embodiment

In the first embodiment, the path loss calculation method that has high measurement precision and that can track the fluctuation by time by using the first reference signal of which measurement precision is high and a receivable interval is long and the second reference signal of which measurement precision is low and a receivable interval is short is described. In this embodiment, a configuration in which a reference signal to be used in the calculation of the path loss is changed according to the circumstance.

As described in the first embodiment, when the difference between the second path loss 41 that can be calculated using the second reference signal and the true path loss 1 as illustrated in FIG. 3 is great, it is difficult to calculate the correct path loss using the second reference signal. However, if correlation between the fluctuation of the true path loss 1 by time and the fluctuation of the second path loss 41 by time is high, and the difference between the path loss 2 using the first reference signal and the path loss 42 using the second reference signal which are measured at the same time is small, it is assumed that the second path loss 41 and the true path loss 1 are substantially the same.

Accordingly, in this embodiment, at the time when the first reference signal and the second reference signal are received at the same time, the difference (decibel value) in the path losses obtained from the two reference signals is measured. The path losses are calculated by using the second reference signal if the absolute value of the difference is within the predetermined value, and the path loss is calculated by using the first reference signal if the absolute value of the difference is greater than the predetermined value.

Accordingly, it is possible to change the reference signals used in the path loss calculation depending on the measurement precision of the second reference signal.

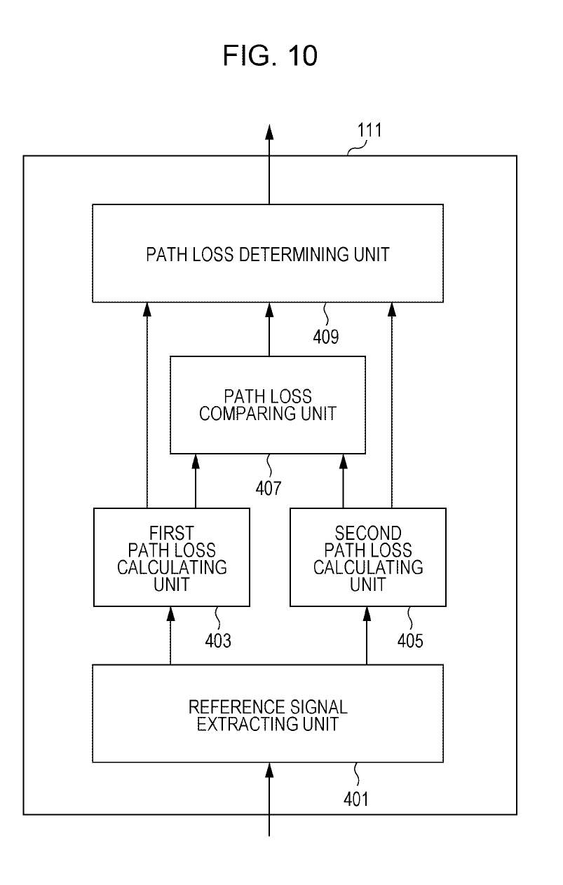

The mobile station device 101 according to the embodiment can be realized by the same block configuration as that of the mobile station device 101 in FIG. 4 according to the first embodiment. However, since the function of the path loss calculating unit 111 is different, the device is described with reference to FIG. 10.

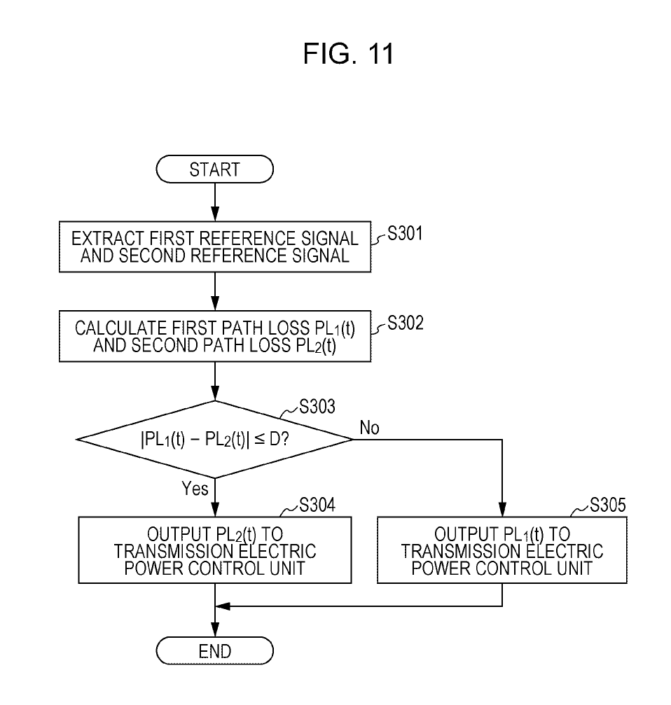

FIG. 10 is a block diagram illustrating a configuration of the path loss calculating unit 111 according to the third embodiment of the invention. The path loss calculating unit 111 includes a reference signal extracting unit 401, a first path loss calculating unit 403, a second path loss calculating unit 405, a path loss comparing unit 407, and a path loss determining unit 409. The processes of the respective blocks are described with reference to the flow chart illustrated in FIG. 11.

FIG. 11 is a flow chart illustrating an operation of the path loss calculating unit 111 according to the third embodiment of the invention. The reference signal extracting unit 401 separates and extracts the first reference signal and the second reference signal from the input reference signal (Step S301), the first reference signal is input to the first path loss calculating unit 403, and the second reference signal the second reference signal is input to the second path loss calculating unit 405. However, at the time when any of reference signals are not received, the reference signal is not extracted.

The first path loss calculating unit 403 calculates the reception power (RSRP₁(t)) of the input first reference signal, and calculates the path loss difference (decibel value) of the calculated reception power from the transmission power of the first reference signal that is notification from the higher layer (not illustrated) by Expression (4) in the same manner as in the first embodiment (Step S302).

[Math. 13]

PL(t)=ReferenceSignalPower₁−RSRP₁(t) (4)

The calculated path loss PL(t) (=PL₁(t)) is input to the path loss comparing unit 407 and the path loss determining unit 409.

The second path loss calculating unit 405 calculates the reception power (RSRP₂(t)) of the input second reference signal, and calculates the path loss difference (decibel value) of the calculated reception power from the transmission power of the second reference signal that is notification from the higher layer (not illustrated) by Expression (13) (Step S302).

[Math. 14]

PL₂(t)=ReferenceSignalPower₂−RSRP₂(t) (13)

Here, ReferenceSignalPower₂ is a transmission power value of the second reference signal, and may be a value which is notification from the higher layer, a value uniquely determined by the transmission power value of the first reference signal, or a value obtained by calculating a relative value from the transmission power of the first reference signal which is notification from the higher layer. Further, RSRP₂(t) is the reception power of the second reference signal at the time t. The calculated path loss PL₂(t) is input to the path loss comparing unit 407 and the path loss determining unit 409.

The path loss comparing unit 407 compares PL₁(t) and PL₂(t) which are input when the first path loss calculating unit 403 and the second path loss calculating unit 405 perform the path loss calculation at the same time t (Step S303). Here, a reference value D is configured in the path loss comparing unit 407. If |PL₁(t)−PL₂(t)|≦D (Step S303: Yes), it is determined to use the second path loss (Step S304), and if |PL₁(t)−PL₂(t)|>D (Step S303: No), it is determined to use the first path loss (Step S305). The path loss determining unit 409 is notified of information on which of the path losses is to be used.

The path loss determining unit 409 outputs any one of the first path loss input from the first path loss calculating unit 403 and the second path loss input from the second path loss calculating unit 405 based on the information which is notification from the path loss comparing unit 407. The information on which of the path losses is to be used is not changed until new notification of information is received from the path loss comparing unit 407 (until the first reference signal and the second reference signal are received at the same time), and is output to the transmission electric power control unit 115 for each time when the transmission power control is performed.

However, the correction by the extrapolation indicated by Expressions (3) and (8) as in the second embodiment can be applied to Expression (4) used by the first path loss calculating unit 403 and Expression (13) used by the second path loss calculating unit 405.

The base station device 201 according to the embodiment can be realized by the block configuration of FIG. 6 according to the first embodiment.

In the above, according to the third embodiment, when the difference between the first path loss measured using the first reference signal and the second path loss measured using the second reference signal is within a predetermined value, a path loss is determined by using the second reference signal of which the measurement interval is short. As a result, it is possible to improve the tracking performance to the fluctuation by time as compared with the case of using only the first reference signal while the measurement precision of the path loss is maintained.

### Fourth Embodiment

In the third embodiment, the configuration of using the second reference signal when it is considered that the measurement precision of the path loss calculated using the second reference signal is high is described. This is because the second reference signal more easily deals with the fluctuation by time than the first reference signal. In the embodiment, on the contrary, a case in which a first reference signal having high measurement precision is used when it is assumed that the fluctuation of the path loss is small is described.

When the fluctuation according to time is great in the same manner as in the true path loss 1 in FIG. 1, the difference from the true path loss 1 is great in the path losses 5, 6, and 7 which are determined at a long measurement interval like the path losses 2, 3, and 4, as described above.

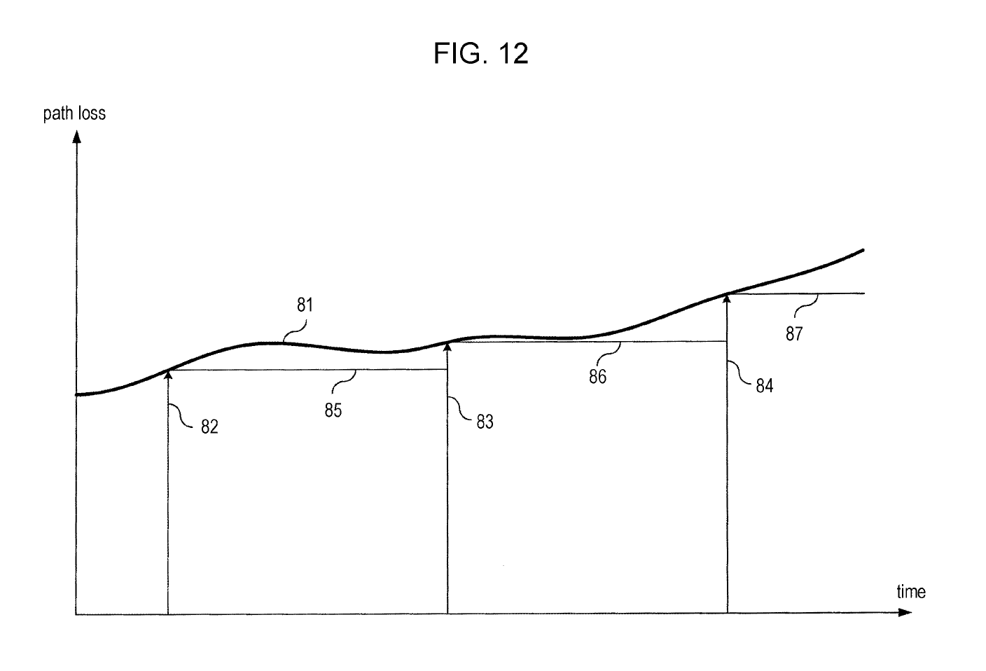

FIG. 12 is a diagram illustrating a relationship between the true value of the path loss and the measured value using the reference signal in the fourth embodiment of the invention. Meanwhile, when the fluctuation by time of a true path loss 81 is small as illustrated in FIG. 12, the values of path losses 82, 83, and 84 measured using the reference signal are not greatly changed. Therefore, the errors between calculated path losses 85, 86, and 87 used in the transmission power control or the like and the true path loss 81 become smaller than in the case of FIG. 1. In this manner, since the influence of the size of the measurement interval changes according to the size of the fluctuation by time, it is effective to change the reference signal used in the measurement according to the measured fluctuation amount of the path loss. Here, an example of changing the reference signal to be used in the calculation of the path loss according to the fluctuation amount of the reception power calculated using the first reference signal is described.

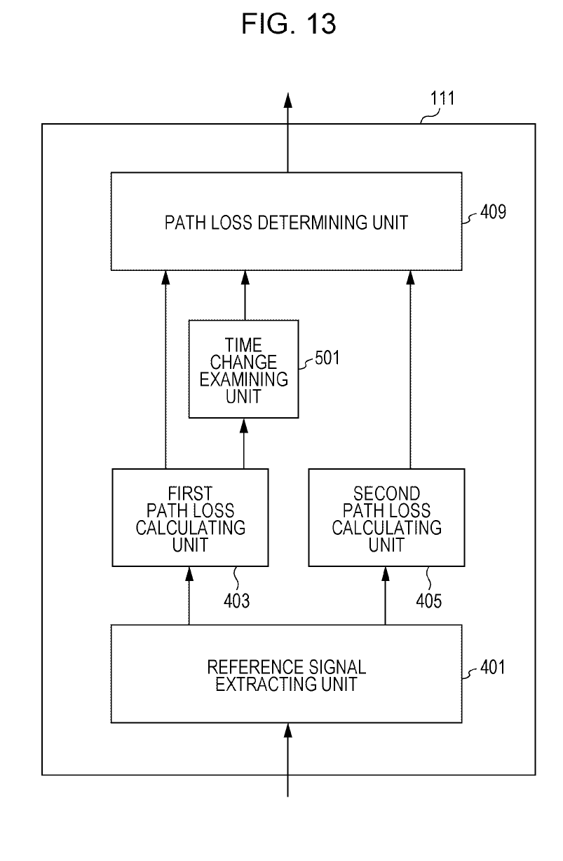

The mobile station device 101 and the base station device 201 according to the embodiment can be realized respectively by the block configurations of FIGS. 4 and 6 according to the first embodiment. However, since the functions in the path loss calculating unit 111 are different, the functions are described with reference to FIG. 13.

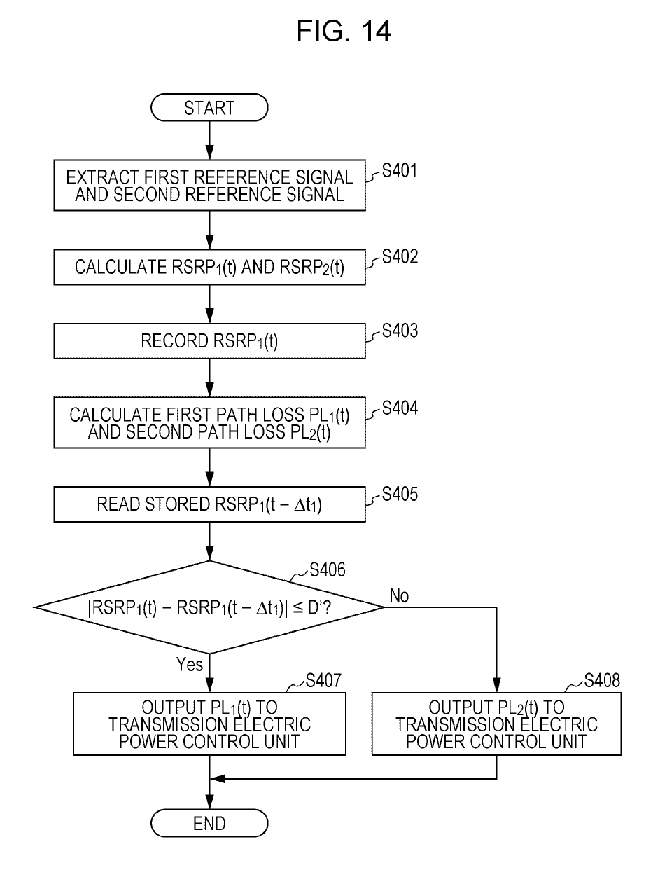

FIG. 13 is a block diagram illustrating the configuration of the path loss calculating unit 111 according to the fourth embodiment of the invention. The path loss calculating unit 111 includes the reference signal extracting unit 401, the first path loss calculating unit 403, the second path loss calculating unit 405, a time change examining unit 501, and the path loss determining unit 409. The processes in the respective blocks are described with reference to the flow chart illustrated in FIG. 14.

FIG. 14 is a flow chart illustrating an operation of the path loss calculating unit 111 according to the fourth embodiment of the invention. The functions in the reference signal extracting unit 401, the first path loss calculating unit 403, and the second path loss calculating unit 405 are the same as those of the blocks having the same reference numbers in FIG. 13 according to the third embodiment (Step S401). However, the first path loss calculating unit 403 inputs the calculated RSRP₁(t) to the time change examining unit 501 (Step S402).

RSRP₁(t) is input to the time change examining unit 501 for each reception interval Δt₁ of the first reference signal, and the time change examining unit 501 stores the input RSRP₁(t) (Step S403). Subsequently, the first path loss calculating unit 403 and the second path loss calculating unit 405 calculate the first path loss PL₁(t), and the second path loss PL₂(t), respectively (Step S404). The time change examining unit 501 reads the stored RSRP₁(t−Δt₁) (Step S405), and calculates the difference ΔRSRP(t) between RSRP₁(t) and RSRP₁(t−Δt₁)=|RSRP₁(t)−RSRP₁(t−Δt₁)|. The time change examining unit 501 compares ΔRSRP(t) with a threshold value D′ determined in advance (Step S406). If ΔRSRP(t)≦D′ (Step S406: Yes), it is determined to use the first path loss (Step S407), and if ΔRSRP(t)>D′ (Step S406: No), it is determined to use the second path loss (Step S408). The determined information is input to the path loss determining unit 409.

Here, it is desirable that the threshold value D′ is a value of a fluctuation by time ΔRSRP(t) when an expected value of the path loss measurement error in the first reference signal and an expected value of the path loss measurement error in the second reference signal are substantially equivalent.

The path loss determining unit 409 selects the first path loss input from the first path loss calculating unit 403 or the second path loss input from the second path loss calculating unit 405 based on the information input by the time change examining unit 501 and inputs the selected path loss to the transmission electric power control unit 115. Here, the information on which of the first path loss and the second path loss is to be used is changed every time the information from the time change examining unit 501 is input.

Here, it is configured that the reception power checked by the time change examining unit 501 is input by the first path loss calculating unit 403. However, the reception power RSRP₂(t) of the second reference signal may be input by the second path loss calculating unit 405. According to the configuration of checking the fluctuation of the second reference signal by time, it is possible to change the path losses to be used at a shorter time interval.

Further, the same function can be obtained by setting the input to the time change examining unit 501 to not be the reception power, but be path losses calculated by the first path loss calculating unit 403 or the second path loss calculating unit 405.

In this example, it is configured that the second path loss is used when ΔRSRP calculated by the time change examining unit 501 is greater than the threshold value D′. However, it can be configured to use the path loss obtained by correcting the path loss calculated using the first reference signal by using the correction value calculated using the second reference signal, as in Expression (6) according to the first embodiment.

In the above, by using the fourth embodiment, it is possible to calculate the path loss by using the first reference signal of which the measurement precision is high when the fluctuation by time is small, and to calculate the path loss by using the second reference signal of which the tracking performance to the fluctuation by time is high when the fluctuation by time is great. As a result, it is possible to reduce the error while maintaining the measurement precision of the path loss, when the fluctuation by time is great.

### Fifth Embodiment

In the first embodiment, a configuration in which the correction value is used in order to reduce the measurement error of the path loss is described. This is not limited to the calculation of the path loss, and can be applied to a case in which the reception power of the reference signal is calculated.

For example, in LTE, a process of notifying the base station device 201 of the reception power (RSRP) of the downlink calculated by the mobile station device 101 is performed (referred to as a measurement report). The RSRP of which the base station device 201 is notified can be used in mobile station device in arbitrary processes such as a handover process or recognition of the movement amount of the mobile station device 101, but when these processes are performed, it is desirable that the processes be controlled based on the path losses between the mobile station device 101 and the base station device 201. Accordingly, a configuration of using the correction value to reduce the measurement error when the reception power (RSRP) is calculated in the mobile station device 101 and a configuration of changing the reference signal to be measured are described in this embodiment. In the configuration of using the correction value, RSRP is calculated by Expression (14).

[Math. 15]

RSRP(t+Δt)=RSRP₁(t)+ΔRSRP(t,t+Δt) (14)

Here, RSRP₁(t+Δt) is an RSRP value at the time when the time Δt passes after the mobile station device 101 receives the first reference signal at the time t, and ΔRSRP(t, t+Δt) is a correction value for estimating RSRP fluctuated between the time t and the time t+Δt.

Here, if the mobile station device 101 according to this embodiment receives the second reference signal having a receivable interval shorter than the first reference signal in the same manner as the mobile station device 101 according to the first embodiment, ΔRSRP(t, t+Δt) in Expression (14) is calculated by Expression (15).

[Math. 16]

ΔRSRP(t,t+Δt)=ΔRSRP₂(t,t+Δt₂)−RSRP₂(t) (15)

Here, RSRP₂(t) is a reception power of the second reference signal received at the time t, and RSRP₂(t+Δt₂) is a reception power of the second reference signal received at the time t+Δt₂ closest to the time t+Δt.

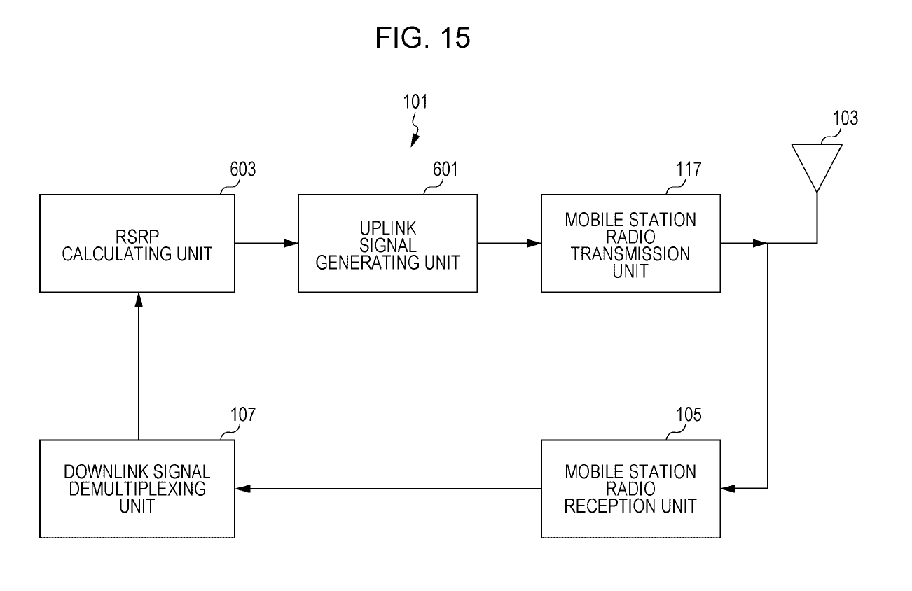

FIG. 15 is a diagram illustrating a block configuration of the mobile station device 101 according to the fifth embodiment of the invention. The functions of the antenna 103, the mobile station radio reception unit 105, and the mobile station radio transmission unit 117 are the same as in the mobile station device 101 of FIG. 4 according to the first embodiment, so the detailed descriptions thereof will be omitted. Further, the downlink signal demultiplexing unit 107 has the same function as the downlink signal demultiplexing unit 107 of the mobile station device 101 of FIG. 4, but outputs only the downlink reference signal which relates to the characteristics of the embodiment, and other outputs are not illustrated. Further, an uplink signal generating unit 601 has the same function as the transmission signal generating unit 109 and the transmission electric power control unit 115 in FIG. 4 according to the first embodiment. An RSRP calculating unit 603 has a function of calculating the RSRP based on the input reference signal.

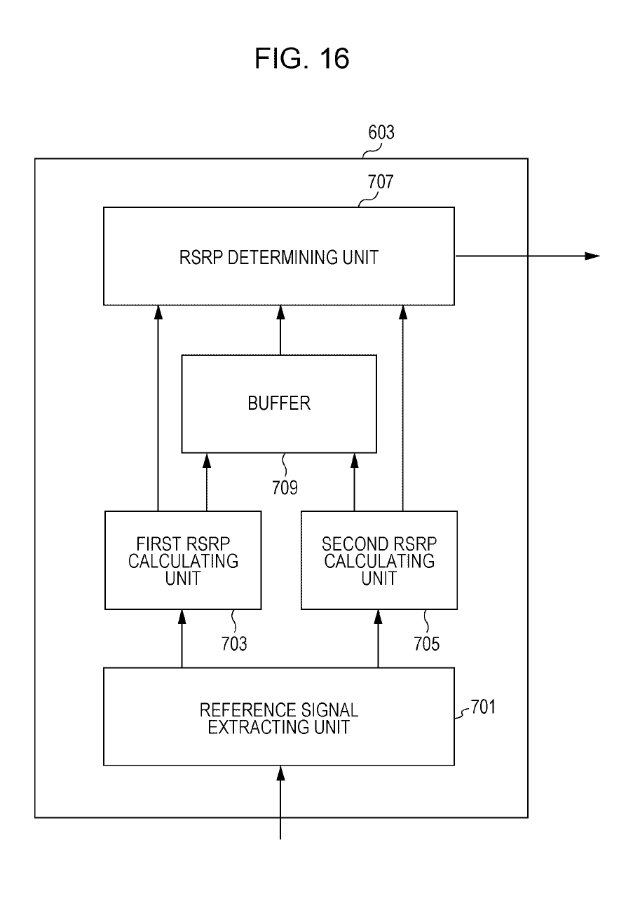

FIG. 16 is a block diagram illustrating an example of an internal configuration of the RSRP calculating unit 603 according to the fifth embodiment of the invention.

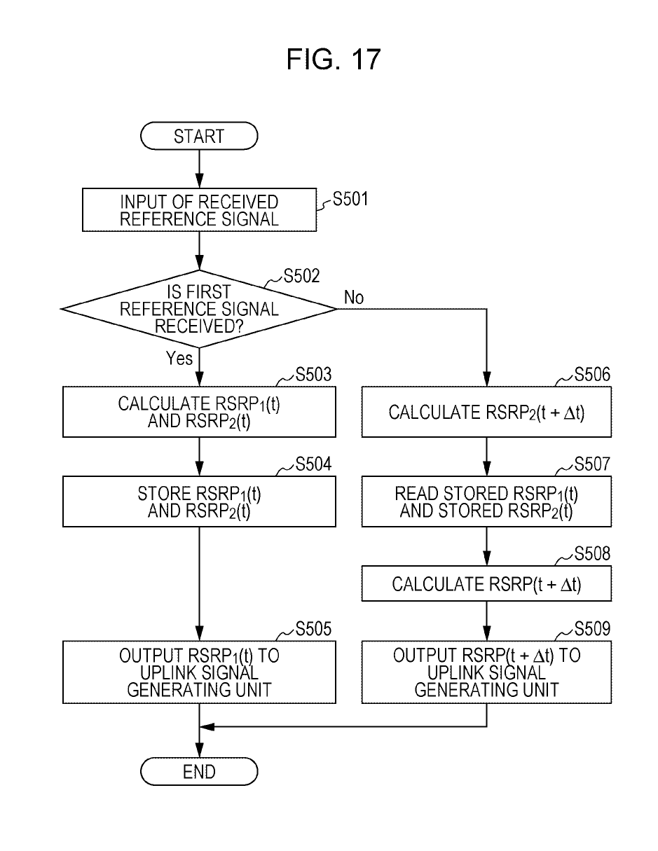

FIG. 17 is a flow chart illustrating a process in the RSRP calculating unit 603 according to the fifth embodiment of the invention.

A reference signal extracting unit 701 extracts the first reference signal and the second reference signal, and inputs the first reference signal and the second reference signal respectively to a first RSRP calculating unit 703 and a second RSRP calculating unit 705 (Step S501). However, when only the second reference signal of which the transmission interval is shorter than that of the first reference signal is received, the second reference signal is input to the second RSRP calculating unit 705. Hereinafter, different processes are performed when two reference signals of the first reference signal and the second reference signal are received, and when only the second reference signal is received (Step S502).

When the first reference signal is received (Step S502: Yes), the first RSRP calculating unit 703 calculates the reception power (RSRP) of the input first reference signal (Step S503). Here, when the RSRP is calculated, a filtering process as in Expression (16) may be performed.

[Math. 17]

RSRP(t)−(1−a)RSRP(t−t′)−aPᵣ(t) (16)

Here, t′ is an elapsed time after the previous RSRP is measured, a is an arbitrary filter coefficient set by the system, and Pᵣ(t) is a reception power of the first reference signal received at the time t. The calculated RSRP is input to an RSRP determining unit 707 and a buffer 709, as a first RSRP (RSRP₁(t)).

The second RSRP calculating unit 705 calculates the RSRP from the second reference signal input when the second reference signal is received (Step S503). The same calculation method as in the first RSRP calculating unit 703 can be used. The calculated RSRP is input, as the second RSRP (RSRP₂(t)), to the buffer 709 at the time t when the first reference signal is received, and is input to the RSRP determining unit 707 at the time t+Δt when the first reference signal is not received.

The buffer 709 stores the RSRP₁(t) and the RSRP₂(t) of the times t when two reference signals of the first reference signal and the second reference signal are received (Step S504), and outputs the RSRP₁(t) and the RSRP₂(t) to the RSRP determining unit 707 when the RSRP(t) is calculated at the time t+Δt when the first reference signal is not received.

If RSRP(t) is output at the time t when two reference signals are received, the RSRP determining unit 707 inputs the RSRP₁(t) input by the first RSRP calculating unit 703 as the RSRP(t) to the uplink signal generating unit (Step S505). Meanwhile, if the RSRP(t+Δt) is output at the time t+Δt when only the second reference signal is received, the RSRP₁(t) of the first reference signal received immediately before and the RSRP₂(t) of the second reference signal received at the point are input from the buffer 709 (Steps S506 and S507), and the RSRP₂(t+Δt) at the time t+Δt is input by the second RSRP calculating unit 705. The RSRP determining unit 707 calculates the fluctuation amount ΔRSRP(t, t+Δt) of the second RSRP from the input RSRP₂(t) and the input RSRP₂(t+Δt) based on Expression (15) (Step S508), calculates the RSRP(t+Δ(t)) based on Expression (14), and inputs the results to the uplink signal generating unit (Step S509).

However, the output timing t+Δt may be a predetermined time interval determined by the system, or may have a configuration of being output only when an arbitrary condition is satisfied.

The uplink signal generating unit performs processes of error correction coding, modulation, and frequency allocation on the input information of RSRP, and inputs the result to the mobile station radio transmission unit 117 as the transmission signal. Here, the information of RSRP may be generated as a transmission signal together with other information bits (not illustrated).

As described above, it is possible to reduce the generation of the measurement errors due to the fluctuation by time using the second reference signal, while the high RSRP measurement precision is obtained using the first reference signal according to the embodiment.

### Sixth Embodiment

In the fifth embodiment, the configuration in which the base station device 201 is notified of the RSRP calculated from the first reference signal and the second reference signal is described. In this embodiment, a configuration is described in which the base station device 201 is notified of RSRP of the reference signal used in the calculation of the path loss by the path loss calculating unit 111 described in the embodiments described above.

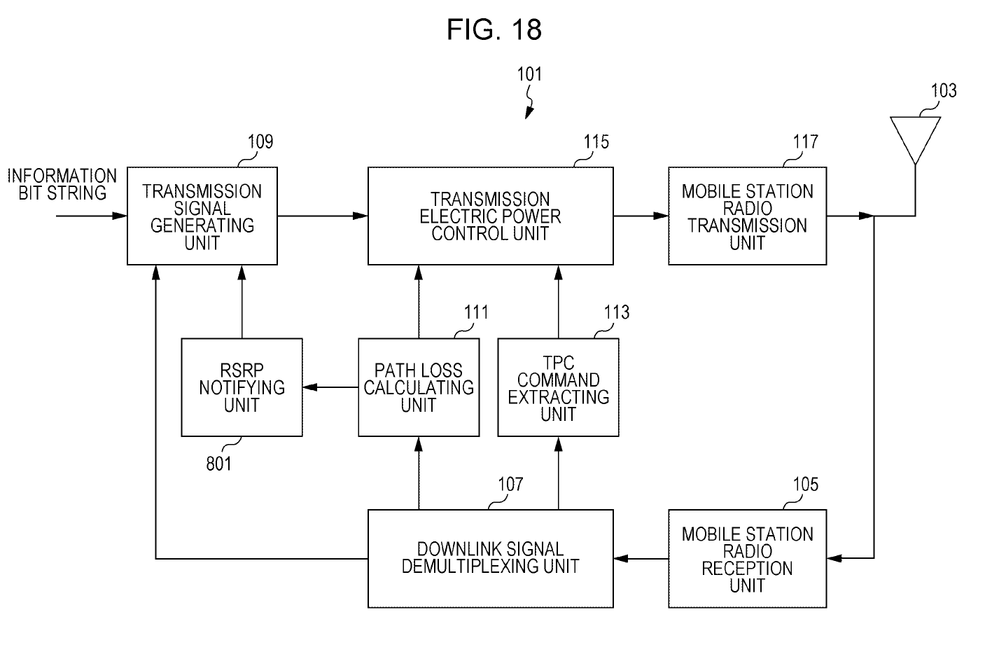

FIG. 18 is a diagram illustrating a block configuration of the mobile station device 101 according to the sixth embodiment of the invention. The mobile station device 101 of FIG. 18 is different from the mobile station device 101 of FIG. 4, in that an RSRP notifying unit 801 is further provided.

The RSRP notifying unit 801 has a function of outputting the first reference signal to be used in the path loss calculating unit 111 or the RSRP calculated using the second reference signal to the transmission signal generating unit 109.

For example, in the path loss calculating unit 111 of FIG. 10 according to the third embodiment, when it is determined that the path loss comparing unit 407 uses the first path loss, the reception power RSRP₁(t) of first reference signal is input to the RSRP notifying unit 801 by the first path loss calculating unit 403. On the contrary, when it is determined that the path loss comparing unit 407 uses the second path loss, the reception power RSRP₂(t) of the second reference signal is input to the RSRP notifying unit 801 by the second path loss calculating unit 405.

Further, for example, in the path loss calculating unit 111 of FIG. 13 according to the fourth embodiment, when it is determined that the time change examining unit 501 uses the first path loss, the reception power RSRP₁(t) of the first reference signal is input to the RSRP notifying unit 801 by the first path loss calculating unit 403. On the contrary, when it is determined that the path loss comparing unit 407 uses the second path loss, the reception power RSRP₂(t) of the second reference signal is input to the RSRP notifying unit 801 by the second path loss calculating unit 405.

The input RSRP is input to the transmission signal generating unit 109 at the time when a condition is satisfied, is generated, as a signal of the higher layer, as the transmission signal in the same manner as the information bit string, and the base station device 201 is notified of the signal through the transmission electric power control unit 115, the mobile station radio transmission unit 117, and the antenna 103.

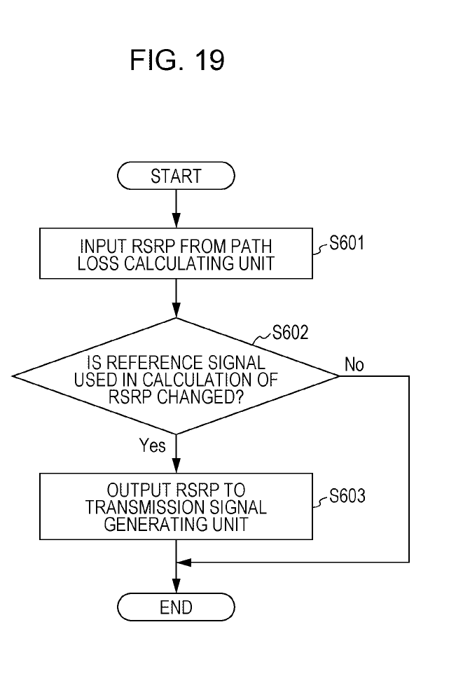

The RSRP notifying unit 801 may be configured to determine whether to output the value of the RSRP to the transmission signal generating unit 109 at a predetermined time interval or to notify the base station apparatus 201 of the RSRP at a predetermined time, and notify the base station device 201 of the RSRP when a condition is satisfied at the time of determination. One example of the condition may be a case where the value of the RSRP fluctuates. Accordingly, as an example according to this embodiment, the RSRP notifying unit 801 inputs the RSRP at the time of the determination after the reference signal used in the path loss calculating unit 111 is changed, to the transmission signal generating unit 109. A flow chart relating to the RSRP notifying unit 801 in the case where notification of the RSRP is performed based on the condition is illustrated in FIG. 19. According to this process, the base station device 201 may follow the fluctuation of the RSRP calculated when the reference signal used in the measurement of the RSRP is changed.

FIG. 19 is a flow chart illustrating an operation of the RSRP notifying unit 801 according to the sixth embodiment of the invention. First, the RSRP notifying unit 801 inputs the RSRP from the path loss calculating unit 111 (Step S601). Subsequently, it is determined whether the reference signal used in the calculation of the RSRP is changed (Step S602). When the reference signal is changed (Step S602: Yes), the RSRP notifying unit 801 outputs the RSRP to the transmission signal generating unit 109 (Step S603). Meanwhile, when the reference signal is not changed (Step S602: No), the RSRP notifying unit 801 does not output the RSRP.

In FIG. 19, a process in which the RSRP is not output when the reference signal used in the calculation of RSRP is not changed is performed, but a process in which other conditions are set and the RSRP is output to the transmission signal generating unit 109 when the conditions are satisfied can be performed. According to the process, in addition to the process of notifying the base station device 201 of the RSRP under an arbitrary condition, the mobile station device 101 may further notify the base station device 201 of the RSRP when the reference signal used in the calculation of the RSRP is changed.

Here, in FIG. 19, a process of outputting the RSRP when the reference signal used in the calculation of the RSRP is changed is performed, but a process of not outputting the RSRP to the transmission signal generating unit 109 when another condition is set and the condition is satisfied may be performed. As an example of the condition, there is a condition whether the fluctuation amount of the RSRP is greater than a threshold value, so that a process of not notifying the base station device 201 of the RSRP even when the reference signal is changed if the fluctuation of the RSRP is small may be performed. According to the process, it is possible to suppress the frequency of the notification of the RSRP, so it is possible to reduce the overhead relating to the notification.

In the above, by using the embodiment, the mobile station device 101 can select an appropriate RSRP from a first reference signal and a second reference signal, notify the base station device 201 of the RSRP, and reduce the error of the reception power recognized by the base station device 201.

A program executed by the mobile station device 101 and the base station device 201 is a program (a program that causes a computer to function) to control a CPU or the like to realize the function according to the embodiments according to the invention. Further, the information dealt with in these devices is temporarily accumulated in a RAM at the time of processing, and thereafter stored in various kinds of ROMs and HDDs, read by the CPU as necessary, and edited or written. As a storage medium to store the program, a semiconductor medium (for example, a ROM and a non-volatile memory card), an optical storage medium (for example, DVD, MO, MD, CD, and BD), a magnetic storage medium (for example, a magnetic tape and a flexible disk), or the like may be included.

Further, the functions of the embodiments described above may be realized by executing the loaded program, and the functions of the embodiments of the invention may be realized by combining and executing an operation system or other application programs, based on the instruction of the program. Further, when distributed in the market, the program is stored in a portable storage medium, or can be transmitted to a server computer connected via a network such as the Internet. In this case, the storage medium of the server computer is included in the invention.

Further, a portion or the entire portion of the mobile station device 101 and the base station device 201 according to the embodiments described above may be realized as LSI which is a typical integrated circuit. The respective functional blocks of the mobile station device 101 and the base station device 201 may be respectively chipped, or a portion or the entire portion can be chipped in an integrated manner. Further, the integrated-circuitizing method is not limited to the LSI, and may be realized as a dedicated circuit or a general processor. Further, in case of advancement of the semiconductor technique, if an integrated-circuitizing technique that can be substituted with the LSI appears, an integrated circuit according to the technique can be used.

In the above, the embodiments of the invention are described with reference to the drawings. However, the specific configurations are not limited to the embodiments, and designs without departing from the gist of the invention are included in the scope of the claims. The invention is suitable for a mobile communication system using a cellular phone as the mobile station device 101, but the invention is not limited thereto.

### REFERENCE SIGNS LIST

1 TRUE PATH LOSS
2, 3, 4 PATH LOSS
5, 6, 7, 8 CALCULATED PATH LOSS
41 SECOND PATH LOSS
42, 43 PATH LOSS
81 TRUE PATH LOSS
82, 83, 84 PATH LOSS
85, 86, 87 CALCULATED PATH LOSS
101 MOBILE STATION DEVICE
103 ANTENNA
105 MOBILE STATION RADIO RECEPTION UNIT
107 DOWNLINK SIGNAL DEMULTIPLEXING UNIT
109 TRANSMISSION SIGNAL GENERATING UNIT
111 PATH LOSS CALCULATING UNIT
113 TPC COMMAND EXTRACTING UNIT
115 TRANSMISSION ELECTRIC POWER CONTROL UNIT
117 MOBILE STATION RADIO TRANSMISSION UNIT
201 BASE STATION DEVICE
203 ANTENNA
204 BASE STATION RADIO RECEPTION UNIT
205 DATA DETECTING UNIT
207 RECEIVED ELECTRIC POWER MEASURING UNIT
209 TPC COMMAND GENERATING UNIT
211 FIRST REFERENCE SIGNAL GENERATING UNIT
213 SECOND REFERENCE SIGNAL GENERATING UNIT
215 CONTROL SIGNAL GENERATING UNIT
217 DOWNLINK SIGNAL MULTIPLEXING UNIT
219 BASE STATION RADIO TRANSMISSION UNIT
301 REFERENCE SIGNAL GENERATING UNIT
401 REFERENCE SIGNAL EXTRACTING UNIT
403 FIRST PATH LOSS CALCULATING UNIT
405 SECOND PATH LOSS CALCULATING UNIT
407 PATH LOSS COMPARING UNIT
409 PATH LOSS DETERMINING UNIT
501 TIME CHANGE EXAMINING UNIT
601 UPLINK SIGNAL GENERATING UNIT
603 RSRP CALCULATING UNIT
701 REFERENCE SIGNAL EXTRACTING UNIT
703 FIRST RSRP CALCULATING UNIT
705 SECOND RSRP CALCULATING UNIT
707 RSRP DETERMINING UNIT
709 BUFFER
801 RSRP NOTIFYING UNIT

1.-12. (canceled)

13. A mobile station device that receives a first reference signal transmitted at a first time interval and a second reference signal transmitted at a time interval shorter than the first time interval from a base station device, the mobile station device comprising:
a path loss calculating unit that calculates a path loss based on both of the first reference signal and the second reference signal, or that selects any one of the first reference signal and the second reference signal in accordance with a condition and calculates the path loss.

14. The mobile station device according to claim 13,
wherein the path loss calculating unit corrects the path loss calculated based on any one of the first reference signal and the second reference signal, based on the other reference signal.

15. The mobile station device according to claim 13,
wherein, when a path loss at a predetermined time is calculated, the path loss calculating unit corrects a path loss calculated based on the first reference signal before the predetermined time by a path loss fluctuation amount calculated based on the second reference signals received at a plurality of timings before the predetermined time.

16. The mobile station device according to claim 13,
wherein the path loss calculating unit calculates a difference between the path loss calculated based on the first reference signal and the path loss calculated based on the second reference signal at a time when the first reference signal and the second reference signal are received at the same time, and sets any one of the path loss calculated based on the first reference signal and the path loss calculated based on the second reference signal to be the downlink path loss based on the difference between the respective calculated path losses.

17. The mobile station device according to claim 16,
wherein the path loss calculating unit sets the path loss calculated based on the second reference signal to be the downlink path loss in a case where the difference between the respective calculated path losses is within a predetermined threshold value.

18. The mobile station device according to claim 13,
wherein the path loss calculating unit calculates a fluctuation amount within a predetermined interval of the path loss calculated based on the first reference signal or a fluctuation amount within a predetermined interval of the path loss calculated based on the second reference signal and sets any one of the path loss calculated based on the first reference signal and the path loss calculated based on the second reference signal to be the downlink path loss based on the calculated fluctuation amount.

19. The mobile station device according to claim 18,
wherein, in a case where the calculated fluctuation amount is within a predetermined threshold value, the path loss calculating unit sets the path loss calculated based on the first reference signal to be the downlink path loss.

20. The mobile station device according to claim 13, further comprising
an RSRP notifying unit that notifies the base station device of a reference signal received power (RSRP) which is a reception power of a reference signal used by the path loss calculating unit in the calculation of the path loss.

21. The mobile station device according to claim 20,
wherein, in a case where the path loss calculating unit changes a reference signal used in the calculation of the path loss, the RSRP notifying unit notifies the base station device of the RSRP.

22. A path loss calculation method of a mobile station device that receives a first reference signal transmitted at a first time interval and a second reference signal transmitted at a time interval shorter than the first time interval from a base station device, the method comprising:
a step of calculating a path loss based on both of the first reference signal and the second reference signal, or selecting any one of the first reference signal and the second reference signal in accordance with a condition and calculating a path loss.

23. An integrated circuit that is mounted on a mobile station device, and causes the mobile station device to operate a plurality of functions of:
receiving a first reference signal transmitted at a first time interval and a second reference signal transmitted at a time interval shorter than the first time interval from a base station device; and
calculating a path loss based on both of the first reference signal and the second reference signal, or selecting any one of the first reference signal and the second reference signal in accordance with a condition and calculating a path loss.
